(19) United States
(12) Patent Application Publication
(10) Pub. No.: US 2017/0220684 A1
(43) Pub. Date: Aug. 3, 2017

(54) SYSTEM, METHOD, AND NON-TRANSITORY COMPUTER-READABLE STORAGE MEDIA FOR DISPLAYING INFORMATION ON MOBILE DEVICES

(71) Applicant: Wal-Mart Stores, Inc., Bentonville, AR (US)

(72) Inventors: Justin Toupin, San Francisco, CA (US); Nathan Thomas Diepenbrock, Highlands Ranch, CO (US)

(21) Appl. No.: 15/009,327

(22) Filed: Jan. 28, 2016

(51) Int. Cl. G06F 17/30; G06Q 10/10; G06F 19/00

(52) U.S. Cl. CPC G06F 17/30867; G06F 19/322; G06F 19/3456; G06Q 10/109

(57) ABSTRACT

A networked computer system for displaying information to a user via a mobile computing device is described herein. The networked computer system includes a database including a list of user pharmacy account records and a server computer. The server computer is programmed to receive a request to display a notification message to a user including a corresponding user ID, access the database, and identify a user pharmacy account record associated with the received user ID. The server computer determines an action record associated with the determined pharmaceutical drug including action event, and initiates a data search operation associated with the action event data. The server computer generates a notification message as a function of the outcome of the data search operation, and generates and transmits a signal including the notification message to the mobile computing device.

### COPYRIGHT NOTICE

The figures included herein contain material that is subject to copyright protection. The copyright owner has no objection to the facsimile reproduction by anyone of this patent document as it appears in the U.S. Patent and Trademark Office, patent file or records, but reserves all copyrights whatsoever in the subject matter presented herein.

### FIELD OF THE DISCLOSURE

U.S. Patent Classification Primary Class: 707 (DATA PROCESSING: DATABASE, DATA MINING, AND FILE MANAGEMENT OR DATA STRUCTURES). Art Unit: 2161.

The present invention relates to providing product information to a consumer, and more particularly, to systems, methods, and computer-readable storage media that monitor activities of pharmacy customers, determine potential drug interactions, and generate and displays product information via a website in response to potential drug interactions.

### BACKGROUND

Many pharmacy consumers desire to obtain information related to the pharmaceutical medications being prescribed to them remotely, e.g., on-line, through the Internet, or using a specially designed application or app on a personal computer or mobile device, such as a tablet or cell phone. At least some known web hosting systems include information associated with pharmaceutical drugs including treated illnesses and potential side effects.

These known systems allow customers to search drug databases for the names of particular pharmaceutical drugs, select one or more drugs stored in the database, and display information related to the selected drugs. However, because of the increasing number of pharmaceutical drugs being made available to consumers and the amount of drug information associated with the pharmaceutical drugs, consumer may become frustrated with the lack of relevant information being provided by known systems. In addition, because of the number of records that may be included in a drug database, at least some known search engines require significant computing time and resources to generate and display the sorted drug lists to the consumer. As the amount of records being included in a database increases, the amount of computing resources that are required to perform the search functions increase, thus reducing the overall performance of known web hosting systems.

The present invention is aimed at one or more of the problems identified above.

### SUMMARY OF THE INVENTION

In different embodiments of the present invention, systems, methods, and computer-readable storage media for generating and displaying information to users via mobile computing devices.

In one embodiment of the present invention, a computer network system for displaying information to a user via a mobile computing device is provided. The computer network system includes a database including a list of user pharmacy account records and a server computer that includes a processor coupled to a memory device. Each user pharmacy account record includes a unique user ID associated with a user, pharmaceutical drug data indicating a corresponding pharmaceutical drug associated with the corresponding user, and an action record associated with the corresponding pharmaceutical drug. The action record includes triggering event data indicating a triggering event and action event data indicating data search operations. The server computer is programmed to receive a request to display a notification message to a user including a corresponding user ID, access the database, and identify a user pharmacy account record associated with the received user ID. The server computer determines a pharmaceutical drug included in the identified pharmaceutical account record and determines an action record associated with the determined pharmaceutical drug including a corresponding triggering event data and action event data. The server computer detects an occurrence of a triggering event as a function of the triggering event data, initiates a data search operation associated with the corresponding action event data upon detecting the occurrence of the triggering event, and determines an outcome of the data search operation. The server computer also generates a notification message as a function of the outcome of the data search operation, and generates and transmits a signal including the notification message to the mobile computing device to cause the mobile computing device to display the notification message on the mobile computing device.

In another embodiment of the present invention, a computer-implemented method of operating a networked computer system for displaying information to a user via a mobile computing device is provided. The networked computer system including a database and a server computer including a processor coupled to a memory device. The method includes the steps of the server computer receiving a request to display a notification message to a user including a corresponding user ID and accessing the database including a list of user pharmacy account records. Each user pharmacy account record includes a unique user ID associated with a user, pharmaceutical drug data indicating a corresponding pharmaceutical drug associated with the corresponding user, and an action record associated with the corresponding pharmaceutical drug. The action record includes triggering event data indicating a triggering event and action event data indicating data search operations. The server computer identifies a user pharmacy account record associated with the received user ID, determines a pharmaceutical drug included in the identified pharmaceutical account record, and determines an action record associated with the determined pharmaceutical drug including a corresponding triggering event data and action event data. The server computer detects an occurrence of a triggering event as a function of the triggering event data, initiates a data search operation associated with the corresponding action event data upon detecting the occurrence of the triggering event, and determines an outcome of the data search operation. The server computer generates a notification message as a function of the outcome of the data search operation; and generates and transmits a signal including the notification message to the mobile computing device to cause the mobile computing device to display the notification message on the mobile computing device.

In yet another embodiment, one or more non-transitory computer-readable storage media, having computer-executable instructions embodied thereon are provided. When executed by at least one processor, the computer-executable instructions cause the processor to receive a request to display a notification message to a user including a corresponding user ID and access a database including a list of user pharmacy account records. Each user pharmacy account record includes a unique user ID associated with a user, pharmaceutical drug data indicating a corresponding pharmaceutical drug associated with the corresponding user, and an action record associated with the corresponding pharmaceutical drug. The action record includes triggering event data indicating a triggering event and action event data indicating data search operations. The processor identifies a user pharmacy account record associated with the received user ID, determines a pharmaceutical drug included in the identified pharmaceutical account record, and determines an action record associated with the determined pharmaceutical drug including a corresponding triggering event data and action event data. The processor detects an occurrence of a triggering event as a function of the triggering event data, initiates a data search operation associated with the corresponding action event data upon detecting the occurrence of the triggering event, and determines an outcome of the data search operation. The processor generates a notification message as a function of the outcome of the data search operation, and generates and transmits a signal including the notification message to the mobile computing device to cause the mobile computing device to display the notification message on the mobile computing device.

### BRIEF DESCRIPTION OF THE FIGURES

Non-limiting and non-exhaustive embodiments of the present invention are described with reference to the following figures. Other advantages of the present disclosure will be readily appreciated, as the same becomes better understood by reference to the following detailed description when considered in connection with the accompanying drawings wherein:

FIG. 1 is a schematic illustrating various aspects of a system, according to the present invention;

FIG. 2 is a schematic illustrating example components of a server computer that may be used with the system shown in FIG. 1, according to an embodiment of the present invention;

FIGS. 3-6 are flowcharts of methods that may be used with the system shown in FIG. 1, according to embodiments of the present invention;

FIGS. 7-11 are illustrations of exemplary database records generated by the system of FIG. 1, according to embodiments of the present invention; and

FIGS. 12-20 are illustrations of exemplary screenshots from the system of FIG. 1, according to an embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible media of expression having computer-usable program code embodied in the media.

Any combination of one or more computer-usable or computer-readable media (or medium) may be utilized. For example, a computer-readable media may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable media that can direct a computer or other programmable data processing apparatus to function in a particular manner, such that the instructions stored in the computer-readable media produce an article of manufacture including instruction means which implement the function/act specified in the flowchart and/or block diagram block or blocks.

Several (or different) elements discussed below, and/or claimed, are described as being “coupled”, “in communication with”, or “configured to be in communication with”. This terminology is intended to be non-limiting, and where appropriate, be interpreted to include without limitation, wired and wireless communication using any one or a plurality of a suitable protocols, as well as communication methods that are constantly maintained, are made on a periodic basis, and/or made or initiated on an as needed basis. The term “coupled” means any suitable communications link, including but not limited to the Internet, a LAN, a cellular network, or any suitable communications link. The communications link may include one or more of a wired and wireless connection and may be always connected, connected on a periodic basis, and/or connected on an as needed basis.

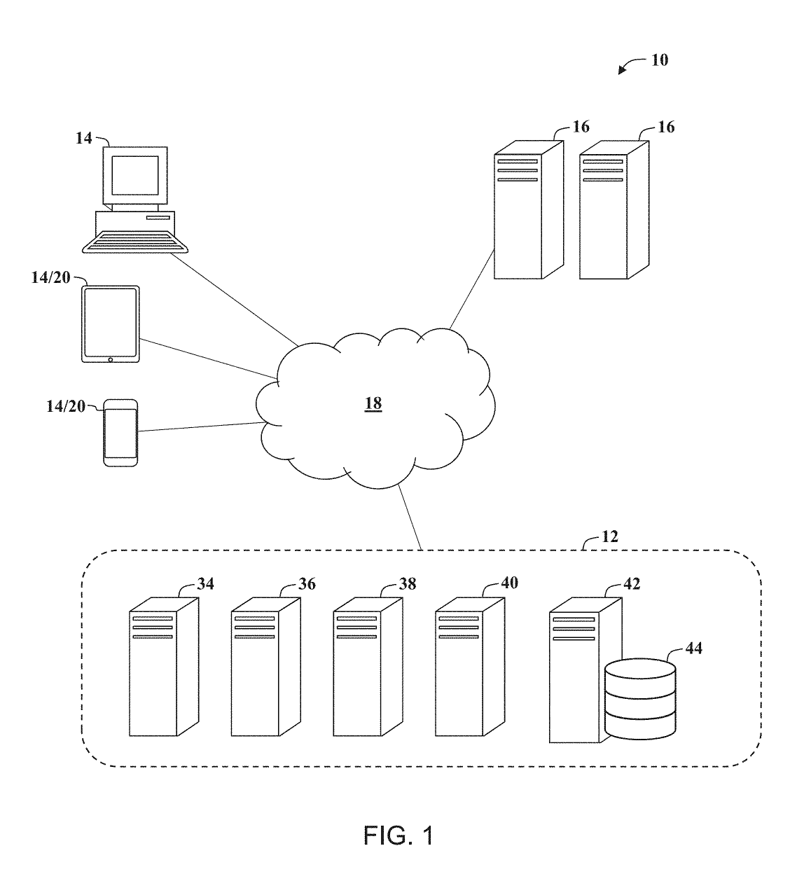

With reference to the FIGS. and in operation, the present invention provides a networked computer system 10, methods and computer product media that monitors the activities of pharmacy customers and provides notification of potential drug interactions to a user via a website. Referring to FIG. 1, an exemplary environment in which the networked computer system 10 operates is illustrated. In general, the present invention describes a networked computer system 10 that monitors activities of pharmacy customers for potential drug interactions and provides pharmacy notifications to customers when potential drug interactions with existing pharmaceutical medications currently used by the customer is detected. Moreover, the networked computer system 10 is configured to communicate with a mobile device associated with the customer to provide push notifications to the mobile devices including messages about the potential drug interactions to the pharmacy customers. In addition, the system 10 may determine the location of the customer based on the geographic location of the corresponding mobile device and determine environmental conditions associated with the geographic area of the mobile device that may affect or require the use of the pharmaceutical medications being used by the customer. The system 10 may then transmit push notifications to the customer with information about current weather conditions in the area and reminders to use the appropriate pharmaceutical drug. The system 10 may also include a mobile computer application being stored on a mobile device associated with the pharmacy customer. The mobile application uses location and public API's to give warnings based on known conditions of the user. For example, in one embodiment, the pharmacy customer receives a push notification warning in the morning because the pollen count in their area is high and they are known users of an allergy medication. The system may also allow the pharmacy customer to identify additional users such as, for example, family, friends, and healthcare professionals, to receive similar notifications to provide the additional users with the information associated with the pharmacy customer.

The system 10 is configured to generate and store user pharmacy data records associated with pharmacy customers that includes information associated with pharmaceutical drugs being used by the customers. The system 10 also determines action events that are associated with the pharmaceutical drugs and generates and stores action records that includes information associated with actions to be performed by the system upon detecting activities being performed by the customer. In addition, the user pharmacy data records may include triggering events that are detected by the system to initiate the action events. The triggering events may include detecting purchases being made by the customers, requests being received by the customers, and/or customer selected calendar dates. The action events may include initiating data search operations to search e-receipt data to determine potential drug interactions and/or provide notifications to the customer of the potential drug interaction via the customer's mobile device.

By generating action event records associated with customer activities that include triggering events that trigger corresponding system actions, the system 10 improves the speed and functionality of known computing systems by reducing the amount of computing time required to monitor customer activity, thus reducing the computing resources required to generate and display relevant pharmacy messages to pharmacy customers.

For clarity in discussing the various functions of the system 10, multiple computers and/or servers are discussed as performing different functions. These different computers (or servers) may, however, be implemented in multiple different ways such as modules within a single computer, as nodes of a computer system, etc. . . . The functions performed by the system 10 (or nodes or modules) may be centralized or distributed in any suitable manner across the system 10 and its components, regardless of the location of specific hardware. Furthermore, specific components of the system 10 may be referenced using functional terminology in their names. The function terminology is used solely for purposes of naming convention and to distinguish one element from another in the following discussion. Unless otherwise specified, the name of an element conveys no specific functionality to the element or component.

Other features of the system 10 can be found in the following commonly owned US patent applications, which are hereby incorporated by reference: U.S. patent application Ser. No. N/A, filed on Jan. 28, 2016 (Attorney Docket Number 068571.00243); U.S. patent application Ser. No. N/A, filed on Jan. 28, 2016 (Attorney Docket Number 068571.00244); U.S. patent application Ser. No. N/A, filed on Jan. 28, 2016 (Attorney Docket Number 068571.00245); U.S. patent application Ser. No. N/A, filed on Jan. 28, 2016 (Attorney Docket Number 068571.00246); U.S. patent application Ser. No. N/A, filed on Jan. 28, 2016 (Attorney Docket Number 068571.00247); U.S. patent application Ser. No. N/A, filed on Jan. 28, 2016 (Attorney Docket Number 068571.00248); U.S. patent application Ser. No. N/A, filed on Jan. 28, 2016 (Attorney Docket Number 068571.00249); U.S. patent application Ser. No. N/A, filed on Jan. 28, 2016 (Attorney Docket Number 068571.00250); U.S. patent application Ser. No. N/A, filed on Jan. 28, 2016 (Attorney Docket Number 068571.00251); U.S. patent application Ser. No. N/A, filed on Jan. 28, 2016 (Attorney Docket Number 068571.00252); and, U.S. patent application Ser. No. N/A, filed on Jan. 28, 2016 (Attorney Docket Number 068571.00253).

In the illustrated embodiment, the system 10 includes a server system 12 that is coupled in communication with one or more user computing devices 14 and one or more 3^{rd} party computer servers 16 via a communications network 18. The communications network 18 may be any suitable connection, including the Internet, file transfer protocol (FTP), an Intranet, LAN, a virtual private network (VPN), cellular networks, etc. . . . , and may utilize any suitable or combination of technologies including, but not limited to wired and wireless connections, always on connections, connections made periodically, and connections made as needed.

The user computing device 14 may include any suitable device that enables a user to access and communicate with the system 10 including sending and/or receiving information to and from the system 10 and displaying information received from the system 10 to a user. For example, in one embodiment, the user computing device 14 may include, but is not limited to, a desktop computer, a laptop or notebook computer, a tablet computer, smartphone/tablet computer hybrid, a personal data assistant, a handheld mobile device including a cellular telephone, and the like. The user computing device 14, as well as any other connected computer systems and their components included in the system 10, can create message related data and exchange message related data (e.g., near field communication (“NFC”) payloads, Bluetooth packets, Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

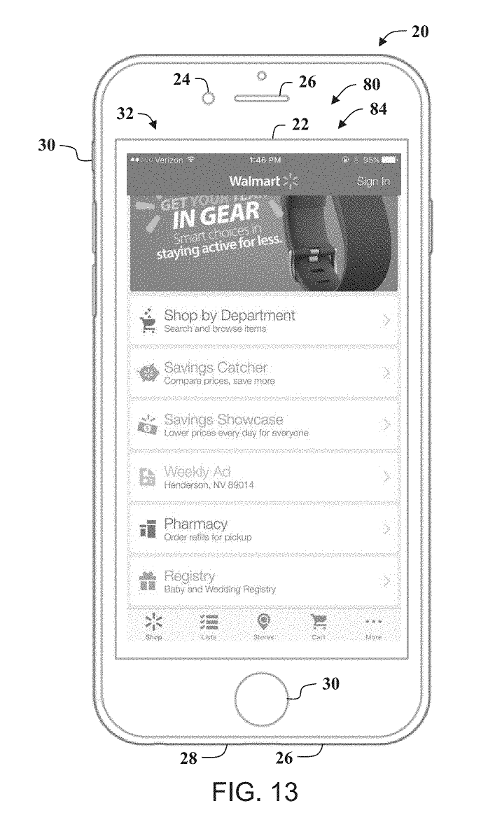

In one embodiment, the user computing device includes a mobile computing device 20 (shown in FIG. 13) such as, for example, a smartphone such as an iPhone™. The mobile computing device 20 includes a processor coupled to a memory device, and a database for storing various programs and data for use in operating the mobile computing device 20. The mobile computing device 20 may also include a touchscreen display device 22, one or more video image cameras 24, one or more speakers 26, a microphone 28, at least one input button 30, and one or more sensors including, but not limited to, a touch ID fingerprint sensor coupled to an input button 30, a barometer, a three-axis gyro, an accelerometer, proximity sensor, and an ambient light sensor. In addition, the mobile computing device 20 may also include a Wi-Fi antenna, a cellular network antenna, a Bluethooth™ communications device, assisted GPS and GLONASS, a digital compass, and an iBeacon microlocation device.

In the illustrated embodiment, the mobile computing device 20 includes a web browser programmed stored in the memory device. The processor executes the web browser program to display web pages on the touchscreen display device 22 that includes information received from the server system 12 to enable a user to interact with and operate the server system 12. In addition, the mobile computing device 20 may be programmed to store and execute a mobile program application, e.g. a mobile application, that displays a user interface 32 (shown in FIG. 13) on the touchscreen display device 22 that allows the user to access the server system 12 to retrieve and store information within the server system 12 as well as interact with and operate the server system 12. In addition, in one embodiment, the system 10 may install one or more mobile application programs in the memory device of the mobile computing device 20. When initiated by the processor of the mobile computing device 20, the mobile application program causes the processor of the mobile computing device 20 to perform some or all of the functions of the server system 12.

The 3^{rd} party computer servers 16 include information and data associated with environmental condition associated with various locations. For example, in one embodiment, the 3^{rd} party computer servers 16 may include environmental information associated with weather conditions for various geographical locations. The environmental information may include, for example, temperature, cloud conditions, wind conditions, air conditions such as dust and/or smog levels, UV data, barometric pressure, humidity, precipitation data, allergy information such as type of pollen and pollen counts, and/or any suitable environmental information associated with geographic locations. In addition, the environmental information may include historic weather and/or allergen conditions, and/or predictive weather and/or allergen conditions.

In the illustrated embodiment, the server system 12 includes a website hosting server 34, an e-receipts server 36, a pharmacy account server 38, a search engine server 40, a database server 42, and a database 44. The database server 42 includes a memory device that is connected to the database 44 to retrieve and store information contained in the database 44. The database 44 contains information on a variety of matters, such as, for example, web pages associated with one or more websites, search queries, pharmaceutical drug information, food-drug interaction data, drug-drug interaction data, customer pharmacy account information, product records, e-receipt data, action events, action trigger conditions, notification messages, mobile device identifies, mobile device application program interfaces (APIs), and/or any suitable information that enables the system 10 to function as described herein. In one embodiment, some or all of the information contained in the database 44 may also be stored in the database of the mobile computing device 20.

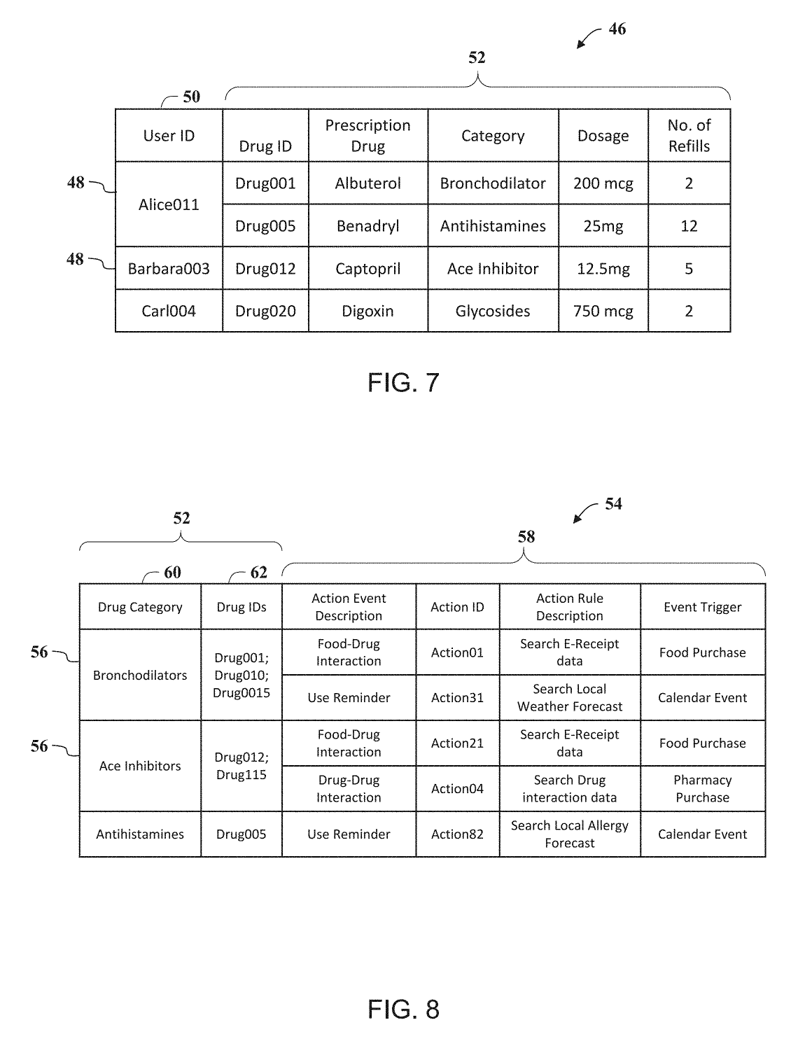

In the illustrated embodiment, the database 44 includes a pharmacy account list 46 (shown in FIG. 7) that includes a plurality of user pharmacy account records 48. Each user pharmacy account record 48 is associated with a corresponding pharmacy customer and includes user identification information 50 associated with the pharmacy customer and pharmaceutical drug information 52 associated with pharmaceutical drugs prescribed to and/or purchased by the corresponding pharmacy customer. The user identification information 50 includes user identifying data such as, for example, a unique ID and/or password. The user identification information 50 may also include user contact information such as, for example, a phone number, an email, and/or a mobile device data associated with a mobile computing device 20 associated with the corresponding pharmacy customer. For example, the mobile device data may include, but is not limited to, a unique mobile device ID, operating system, phone number, IP address, mobile device API, and/or any suitable information that enables the system 10 to communicate with the corresponding mobile computing device 20. The pharmaceutical drug information 52 includes information associated with a corresponding pharmaceutical drug such as, for example, a unique drug ID associated with the pharmaceutical drug, a drug name, drug category, prescribed use information, dosage, number of refills, side effects, and/or any suitable information associated with the corresponding pharmaceutical drug.

In one embodiment, the database 44 also includes a drug action list 54 that includes a plurality of pharmaceutical drug action records 56. Each pharmaceutical drug action record 56 includes pharmaceutical drug information 52 and corresponding action records 58. The drug information includes information associated with pharmaceutical drugs such as, for example, drug categories 60 and drug identifiers 62 associated with the corresponding drug categories. Each action record 56 is associated with one or more drug identifiers 62 and includes and action record ID and information associated with actions and/or operations that may be initiated by the system 10.

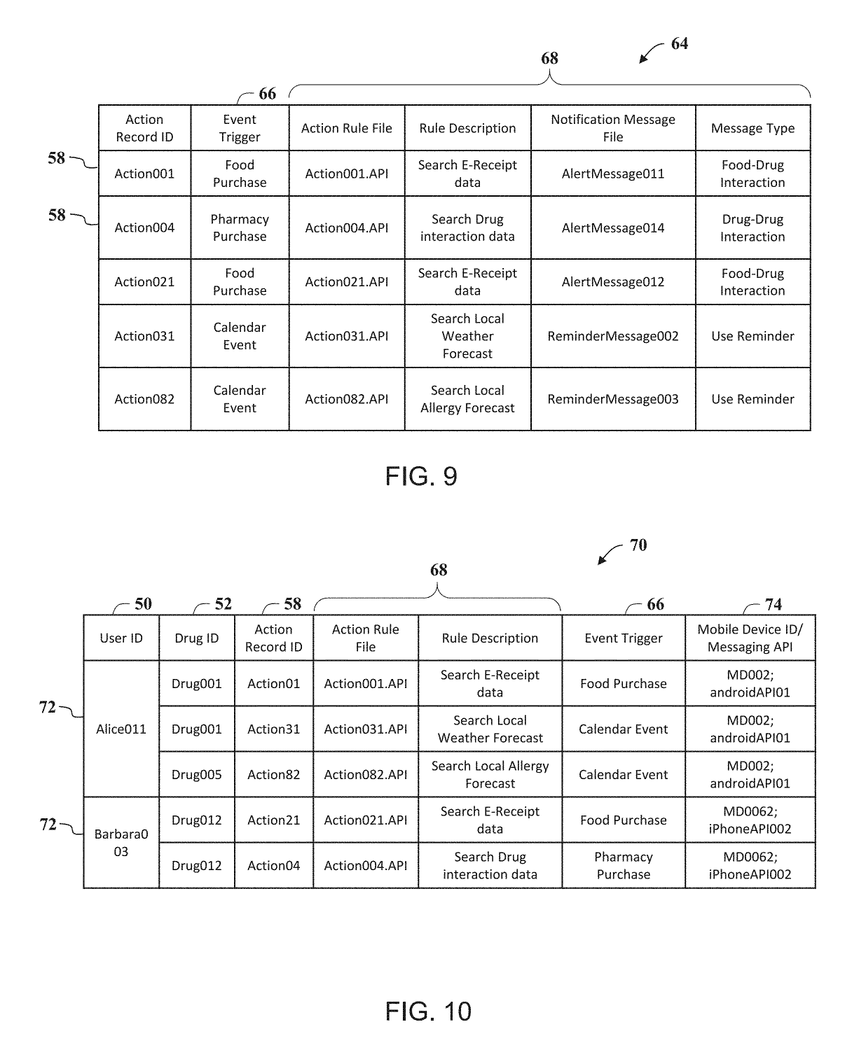

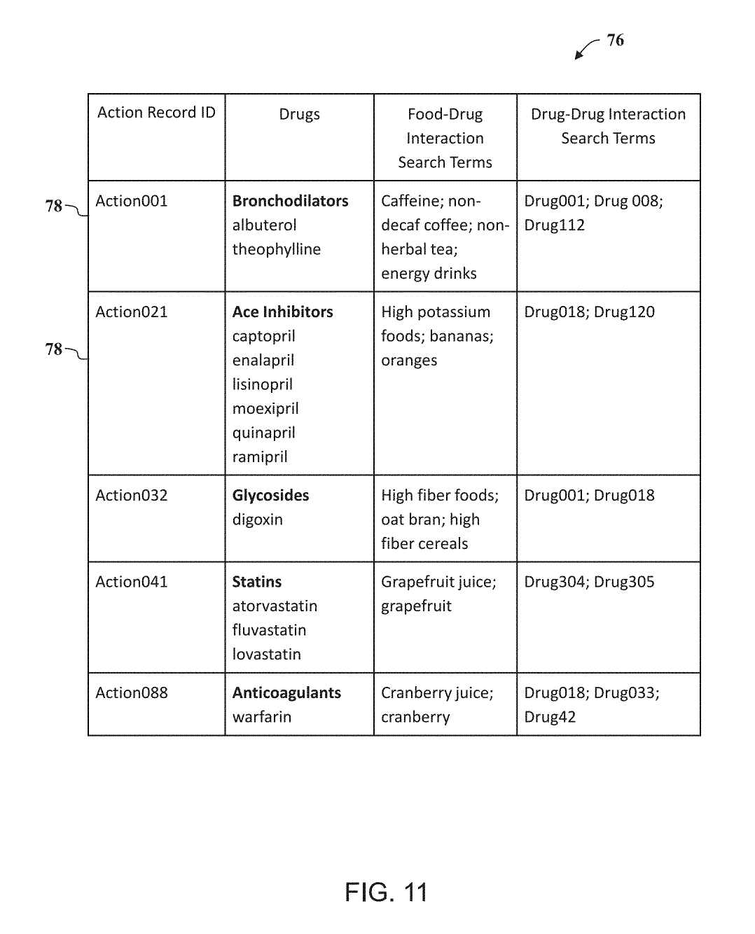

In one embodiment, the database 44 may also include an action event list 64 (shown in FIG. 9) that includes a plurality of action records 58. Each action record 58 may include triggering event data 66 indicating a triggering event and action event data 68 associated with an action and/or operation that may be initiated by the system 10. Action event data 68 includes information and data including, but are not limited to, action event descriptions, an action record ID, and/or action rule description. As shown in FIGS. 9 and 10, the action event description may include data associated with food-drug interactions, drug-drug interactions, and/or use reminders. The action rule description includes data that enables the system to perform particular actions and operations associated with the corresponding action record. For example, in one embodiment, the action rule description may include data that enables the system 10 to initiate a data search operation that searches e-receipt data for purchases the include foods and/or drugs that may interact with the corresponding pharmaceutical drug, and/or perform a search for weather data that may trigger medication reminder notifications. The triggering event data 66 includes data associated with a triggering event that includes an event or occurrence that may be detected by the system 10. Event triggers may include, but are not limited to, requests and/or signals received by a user computing device 14, a consumer product purchase, a pharmaceutical drug purchase, calendar events such as, for example, a day of the week, month, and/or year, a time of day, and/or any suitable triggering event that enable the system 10 to perform as described herein.

The database 44 may also include a user action event list 70 (shown in FIG. 10) that include a plurality of user event action records 72 that are associated with a plurality of pharmacy customers. Each user event action record 72 includes a user ID 50 associated with the corresponding pharmacy customer, a drug identifier 52 indicating pharmaceutical drugs associated with the corresponding user ID 50, and an action record 58 associated with each corresponding pharmaceutical drug. In addition, the user event action record 72 may also include messaging information 74 including data and information associated with a mobile computing device 20 associated with the corresponding user ID and/or API information associated with the corresponding mobile computing device 20. In one embodiment, the messaging information 74 may also include contact information such as, for example, emails and/or text and phone numbers, associated with friends, relatives, and/or healthcare professionals associated with the pharmacy customer. The pharmacy customer may identify one or more additional users that may receive notifications generated by the pharmacy account server 38 and include contact information associated with the identified additional users in the messaging information 74.

In one embodiment, the database 44 may include a drug interaction search term list 76 that includes information and search terms for use in performing data search operations. The drug interaction search term list 76 includes a plurality of data search records 78. Each data search record 78 includes information associated with a corresponding action event. For example, the information included in the data search record 78 may include and action ID associated with a corresponding action event, associated drug information, food-interaction search terms, and/or drug interaction search terms.

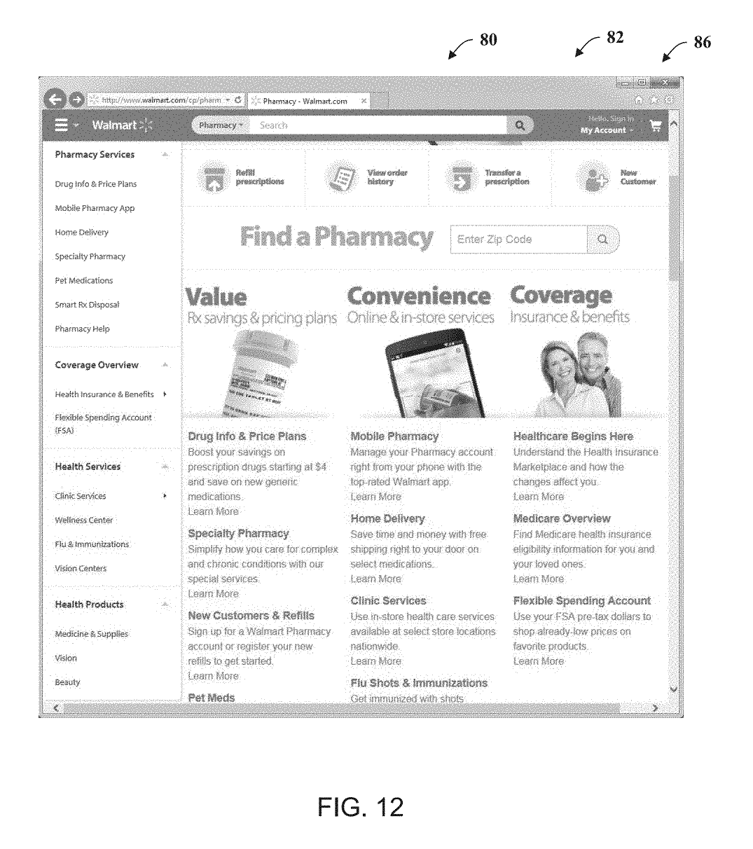

The website hosting server 34 is configured to host a website 80 that is accessible by a user via one or more user computing devices 14. The website hosting server 34 retrieves and stores web pages 82 (shown in FIG. 12) associated with one or more websites 80 in response to requests received by the user via the user computing device 14 to allow users to interact with the website and search and/or purchase products such as, for example, goods and/or services via the website. In one embodiment, the website hosting server 34 is configured to generate and display web pages 82 associated with the website in response to requests being received from consumers via corresponding web browsers that are displayed on the user computing devices 14. In addition, the website hosting server 34 may be configured to generate and display a mobile webpage 84 (shown in FIGS. 13-20) that is displayed on one or more mobile computing devices 20. For example, in one embodiment, the website hosting server 34 may display a pharmacy webpage 86 (shown in FIG. 12) in response to receiving a user request that allows a user to access a corresponding customer pharmacy account record 48 and to input a product search request including search criteria including one or more search terms.

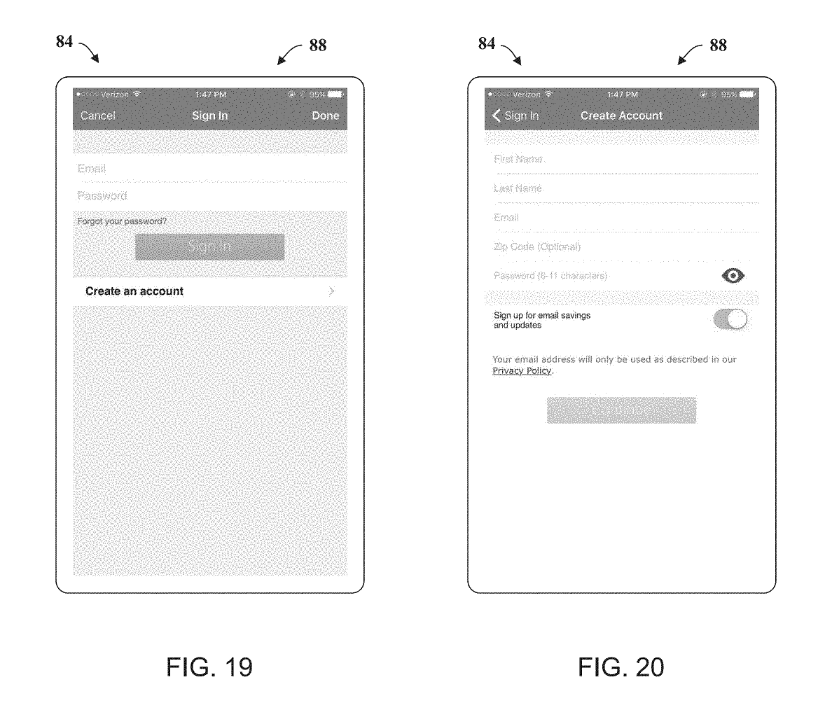

In one embodiment, the website hosting server 34 may allow customers to login and access corresponding customer pharmacy accounts including account information such as, for example, previous purchase, pending prescription orders, pending medication refills, and/or pharmaceutical drug information. For example, the website hosting server 34 may display a login page 88 (shown in FIGS. 19-20), receive a unique customer ID such as, for example, a username and/or password, and identify the customer account associated with the unique customer ID to enable the identified customer to access information and/or features associated with the corresponding customer pharmacy account. In addition, the website hosting server 34 may transmit search requests to the search engine server 40 and/or the pharmacy account server 38 for use in generating search data and/or pharmacy information in response to the user's search request. The website hosting server 34 may also receive one or more product lists from the search engine server 40 and/or the pharmacy account server 38 that includes information associated with products that are selected based on the user's search criteria. The website hosting server 34 may also display a search results webpage to display the product lists to the user and to allow the user to select one or more of the displayed products for purchase.

The e-receipts server 36 receives and stores information associated with consumer retail purchases in the database 44 and is programmed to generate and store electronic receipt data associated with the consumer retail purchases. In addition, the e-receipts server 36 may be programmed to transmit signals indicating consumer purchases to the pharmacy account server 38. For example, in one embodiment, the e-receipts server 36 may communicate with a plurality of point-of-sale (POS) systems as well as other computer systems at each of the one or more physical store locations (e.g., on an internal corporate network) to facilitate business operations for the corresponding entity. The e-receipts server 36 is programmed to receive application identifiers and digital receipt data, including item data for one or more purchased items, from POS systems at various different store locations, and generate and store digital receipts from received receipt data. Generating digital receipts can include item data for items included in corresponding digital receipt data (but potentially in a different format, for example, a format deliverable to mobile devices). Formulated digital receipts can also contain other data related to a transaction, such as, for example, the payment method used for the transaction, coupons, surveys, etc. Additional details of adjacent special symbol positions, which may be used in the present invention, are described in U.S. patent application Ser. No. 13/730,721 to Argue et al, filed Dec. 28, 2012, titled “Searching Digital Receipts at a Mobile Device”, the disclosure of which is incorporated herein by reference in its entirety.

In the illustrated embodiment, the search engine server 40 is configured to receive a search request from the website hosting server 34 and/or the pharmacy account server 38 including one or more search terms, and generate search data including a plurality of records as a function of the search terms. For example, in one embodiment, the search engine server 40 may initiate a search algorithm based on a Boolean model to search pharmacy records and/or search terms contained in the drug interaction search term list 76 contained in the database 44 based search terms received from the user and/or received from the pharmacy account server 38. The search engine server 40 may generate search data including pharmaceutical drugs matching the search criteria, generate a relevance score associated with each pharmaceutical drug included in the search data, and transmit the relevancy score to the pharmacy account server 38. In one embodiment, the relevance score may be determined based on statistical information, including, but not limited to the number of records in the database, the frequency in which the search terms appear in the database, and the frequency in which the search term appears in the pharmaceutical drug record. The relevance of a returned search record may be determined based on the corresponding relevance score and the relevance scores of the other pharmaceutical drugs records in the search data, wherein records having a higher relevance scores are more relevant to the search criteria.

In the illustrated embodiment, the pharmacy account server 38 is programmed to monitor activities associated with prescription drugs being used by pharmacy customers. For example, in one embodiment, the pharmacy account server 38 is configured to monitor consumer product purchases being made by pharmacy customers in order to determine potential drug interactions and/or food interactions with currently prescribed prescriptions drugs being used by the corresponding pharmacy customers. In addition, the pharmacy account server 38 is programmed to detect the occurrence of triggering events associated with pharmaceutical drugs being used by pharmacy customers and transmit pharmacy notification messages to the customers to provide information and notifications of the potential interactions. In addition, the pharmacy account server 38 may also be programmed to monitor environmental conditions associated the geographic locations of the pharmacy customers for use in generating pharmacy notification messages that include reminders for taking prescription allergy medication.

In the illustrated embodiment, the pharmacy account server 38 is programmed to receive a signal indicating a purchase of a pharmaceutical drug by a pharmacy customer. The signal may include an indication of a purchase being made by the customer and be received from the e-receipts server 36 and/or include a request to fill a prescription received from the pharmacy website 86. In addition, the signal may include a pharmaceutical drug ID and a user ID. In one embodiment, the pharmacy account server 38 may access the pharmacy account list 46 being stored in the database an determine the user pharmacy account records 48 that is associated with the received user ID, determine one or more pharmaceutical drugs associated with the user ID, and determine the pharmaceutical drug ID associated with each corresponding pharmaceutical drug.

In the illustrated embodiment, the pharmacy account server 38 determines a drug category associated with each drug ID, and accesses the drug action list 54 included in the database 44 to determine a drug action record 56 associated with each corresponding pharmaceutical drug as a function of the determined drug category and the corresponding drug ID. The pharmacy account server 38 determines the action ID associated with the drug action record 56 and accesses the action event list 64 to obtain the corresponding action record 58 including the triggering event data 66 and action event data 68 associated with the action ID. The pharmacy account server 38 may then generate and store a user event action record 72 associated with the user ID including the information contained in the action record 58 and information associated with a pharmacy notification message associated with the action record 58.

For example, in one embodiment, the pharmacy account server 38 may receive a signal indicating a purchase of a pharmaceutical drug including a pharmaceutical drug ID and a user ID, access the drug action list 54 including pharmaceutical drug action records being stored in the database 44, select a pharmaceutical drug action record as a function of the received pharmaceutical drug ID, determine the action event data associated with the selected pharmaceutical drug action record, and generate a user pharmacy account record associated with the received user ID including the determined action event data associated with the selected pharmaceutical drug action record. The corresponding user pharmacy account record includes information that allows the pharmacy account server 38 to monitor purchases being made by the pharmacy customer to facilitate notifying the pharmacy customer of potential food and drug interactions with current prescription medications.

In the illustrated embodiment, the pharmacy account server 38 receives a request to display a pharmacy notification message to a user via a user computing device 14. For example, the pharmacy notification message may include information associated with a medication reminder and/or a drug interaction. In one embodiment, the pharmacy account server 38 may receive a request to display the pharmacy notification message on a mobile computing device 20. In the illustrated embodiment, the request includes a corresponding user ID. Upon receiving the request, the pharmacy account server 38 accesses the database 44 and identifies a user pharmacy account record 48 associated with the received user ID. The pharmacy account server 38 is programmed to determine a pharmaceutical drug included in the identified user pharmacy account record 48 and determines an action record 58 associated with the determined pharmaceutical drug. The pharmacy account server 38 also determines the triggering event data and the action event data corresponding to the action record 58.

The pharmacy account server 38 also detects an occurrence of a triggering event as a function of the triggering event data, and initiates a data search operation associated with the corresponding action event data upon detecting the occurrence of the triggering event. The pharmacy account server 38 then determines an outcome of the data search operation and generates a pharmacy notification message 90 as a function of the outcome of the data search operation. The pharmacy account server 38 then generates and transmits a signal including the pharmacy notification message to the mobile computing device 20 to cause the mobile computing device 20 to display the pharmacy notification message on the mobile computing device 20.

In one embodiment, the pharmacy account server 38 may determine the triggering event to include an indication of a purchase of consumer products by the user. In addition, the triggering event may include a purchase of pharmaceutical drugs by the user and/or a request to fill a prescription for pharmaceutical drugs being submitted through the website 80. For example, the pharmacy account server 38 may receive a signal from the e-receipts server 36 indicating a purchase being made by a customer. The signal may include a user ID associated with the customer. In addition, the pharmacy account server 38 may receive electronic receipt data including product information associated with consumer products purchased by the user from the e-receipts server 36. In one embodiment, the pharmacy account server may retrieve the electronic receipt data from the database 44 using the corresponding user ID.

Upon receiving the electronic receipt data, the pharmacy account server 38 initiates the data search operation including transmitting the electronic receipt data to the search engine server 40 for use in conducted the data search operation using the electronic receipt data. In one embodiment, during the data search operation, the pharmacy account server 38 generates search terms associated with the pharmaceutical drug included in the identified user pharmacy account record 48 and transmits the search terms to the search engine server 40. In one embodiment, the pharmacy account server 38 is programmed to access the drug interaction search term list 76 being stored in the database 44 to determine search terms associated with the determined pharmaceutical drug included in the associated user pharmacy account record 48, and transmits the determined search terms to the search engine server 40. The search engine server 40 conducts a data search operation to review the electronic receipt data to determine if at least one consumer product included in the electronic receipt data includes product information matching the determined search terms. In one embodiment, the search engine server 40 transmits the matching search terms to the pharmacy account server 38 for use in generating the pharmacy notification message.

For example, the pharmacy account server 38 may transmit the notification message upon determining at least one consumer product includes product information matching one or more of the determined search terms associated with the determined pharmaceutical drug. In one embodiment, search terms may be associated with other pharmaceutical drugs. The pharmacy account server 38 may select a notification message indicating a potential drug-drug interaction if the search engine server 40 returns a matching drug purchased by the consumer. In addition, in one embodiment, the search terms may be associated with food products. The pharmacy account server 38 may select a notification message indicating a potential food-drug interaction if the search engine server 40 returns a matching food purchased by the consumer.

In one embodiment, the triggering event may include a request for allergy information being received from a customer's mobile computing device 20. Upon receiving a request for allergy information, the pharmacy account server 38 may request and receive weather data including location data and associated allergen data from the 3^{rd} party computer server 16. The pharmacy account server 38 may initiate the data search operation including, receiving location data from the corresponding mobile computing device 20, determine a current location of the mobile computing device 20, review the received weather data to identify location data matching the current location of the mobile computing device, and determine an allergen count value as a function of the allergen data associated with the identified location data. For example, the pharmacy account server 38 may generate a pollen count value as a function of the allergen data received from the 3^{rd} party computer server 16. In the illustrated embodiment, the pharmacy account server 38 determines if the allergen count associated with the location of the mobile computing device 20 is equal to, or greater than, a predefined allergen count, and generates and transmits a pharmacy notification message upon determining the determined allergen count value to be greater than, or equal to, the predefined allergen count value.

In one embodiment, the pharmacy account server 38 may allow the user to establish a calendar event as the triggering event to allow the system 10 to perform a daily, weekly, and or monthly review of environmental allergies. In addition, the user may establish triggering events associated with food-drug interactions. For example, in one embodiment, the pharmacy account server 38 may display a notification trigger webpage (not shown) to allow the user to establish triggering events associated with the corresponding user pharmacy account record 48. The user may establish calendared reminders to prompt the pharmacy account server 38 to conduct data search operations upon the occurrence of user defined events. In addition, the pharmacy account server 38 may allow the user to op-out of push notifications and not receive notifications generated by the system 10.

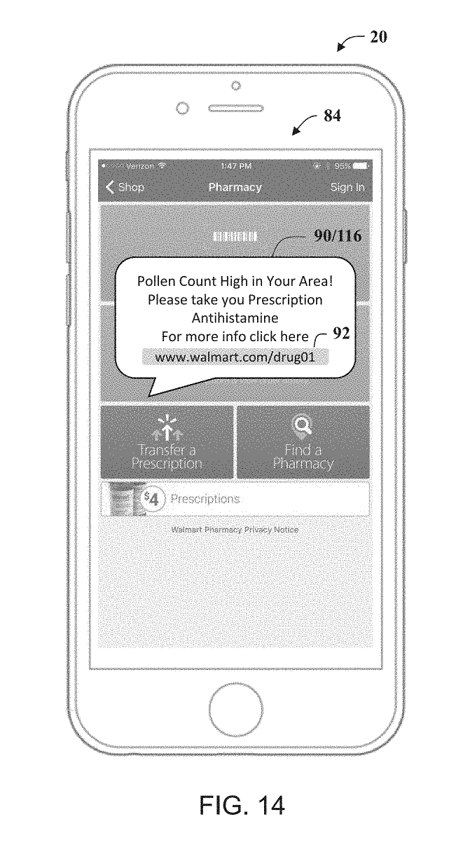

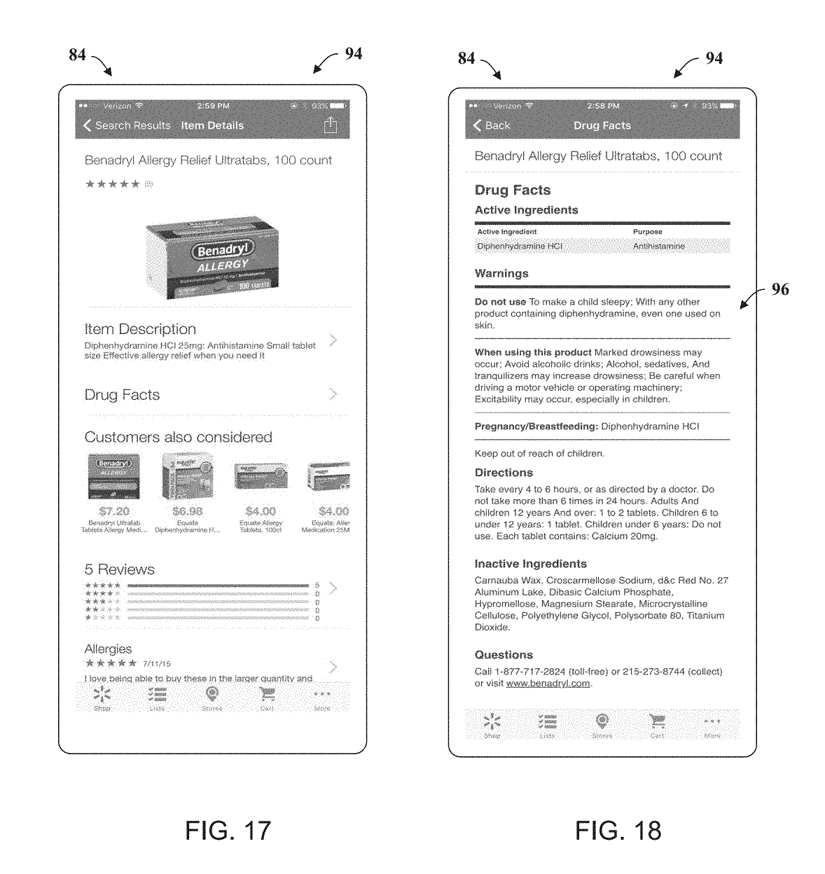

Referring to FIGS. 14-16, in one embodiment, the pharmacy account server 38 may generate the notification message including a hyperlink 92 including a pharmaceutical drug ID to allow the user to cause the system 10 to display additional information associated with the corresponding pharmaceutical drug. For example, the pharmacy account server 38 may receive a signal from the mobile computing device 20 indicating that the user has accessed the hyperlink 92, access the list 54 of pharmaceutical drug records 56 stored in the database 44 with each pharmaceutical drug record 56 associated with a pharmaceutical drug and including a corresponding pharmaceutical drug ID and corresponding pharmaceutical drug data information associated including information associated with the corresponding pharmaceutical drug. The pharmacy account server 38 then retrieves the pharmaceutical drug record corresponding to the received pharmaceutical drug ID and generates and displays an information webpage 94 (shown in FIGS. 17-18) on the mobile computing device 20 including drug-related information 96 included in the retrieved pharmaceutical drug record 56.

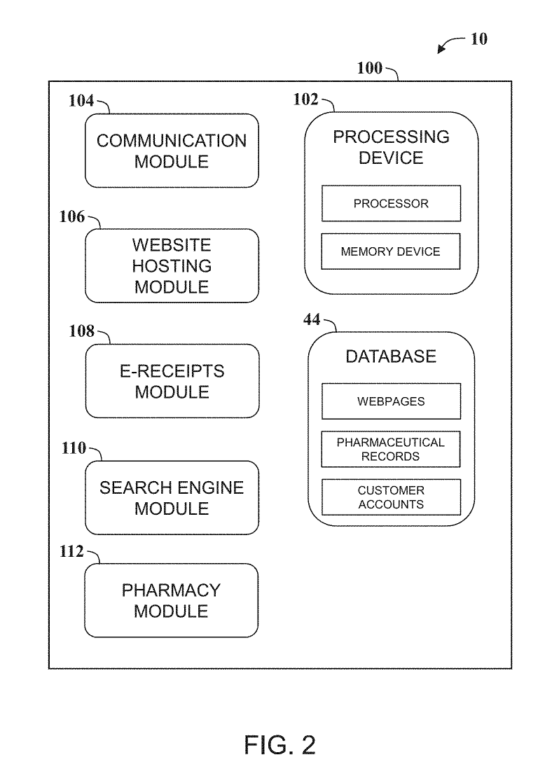

Referring to FIG. 2, in one embodiment, the system 10 may include a system server 100 that is configured to perform the functions of the website hosting server 34, the e-receipts server 36, the pharmacy account server 38, the search engine server 40, and the database server 42. In the illustrated embodiment, the system server 100 includes a processing device 102 and the database 44.

The processing device 102 executes various programs, and thereby controls components of the system server 100 according to user instructions received from the user computing device 14. The processing device 102 may include memory, e.g., read only memory (ROM) and random access memory (RAM), storing processor-executable instructions and one or more processors that execute the processor-executable instructions. In embodiments where the processing device 102 includes two or more processors, the processors can operate in a parallel or distributed manner. In an example, the processing device 102 may execute a communications module 104, a the website hosting module 106, an e-receipts module 108, a search engine module 110, and a pharmacy account module 112, and,

The processing device 102 may also include a memory device for storing programs and information in the database 44, and retrieving information from the database 44 that is used by the processor to perform various functions described herein. The memory device may include, but is not limited to, a hard disc drive, an optical disc drive, and/or a flash memory drive. Further, the memory device may be distributed and located at multiple locations.

The communications module 104 retrieves various data and information from the database 44 and sends information to the user computing device 14 via the communications network 18 to enable the user to access and interact with the system 10. In one embodiment, the communications module 104 displays various images on a graphical interface of the user computing device 14 preferably by using computer graphics and image data stored in the database 44 including, but not limited to, web pages, pharmacy records, pharmacy notification messages, product lists, and/or any suitable information and/or images that enable the system 10 to function as described herein.

The website hosting module 106 may be programmed to perform some or all of the functions of the website hosting server 34 including hosting various web pages associated with one or more websites that are stored in the database 44 and that are accessible to the user via the user computing device 14. The website hosting module 106 may be programmed to generate and display web pages associated with a website in response to requests being received from users via corresponding web browsers.

The e-receipts module 108 may be programmed to perform some or all of the functions of the e-receipts serve 36 including generating, receiving, and storing e-receipt data in the database 44 and detecting purchases being made by the pharmacy customers.

The search engine module 110 may be programmed to perform some or all of the functions of the search engine server 40 including generating and storing search data in response to the user's product search request and/or pharmacy account module 112 search requests. In addition, the search engine module 110 may also be programmed to generate a relevance score associated with each of the records included in the search data.

The pharmacy account module 112 may be programmed to perform some or all of the functions of the pharmacy account server 38 including monitoring activities associated with pharmacy customers including consumer purchase and/or prescription refill requests and generate notification messages associated with the monitored activities. In addition, the pharmacy account module 112 may be programmed to perform calendared tasks requested by the user including scheduled review of environmental information associated with a geographic location of a mobile computing device 20.

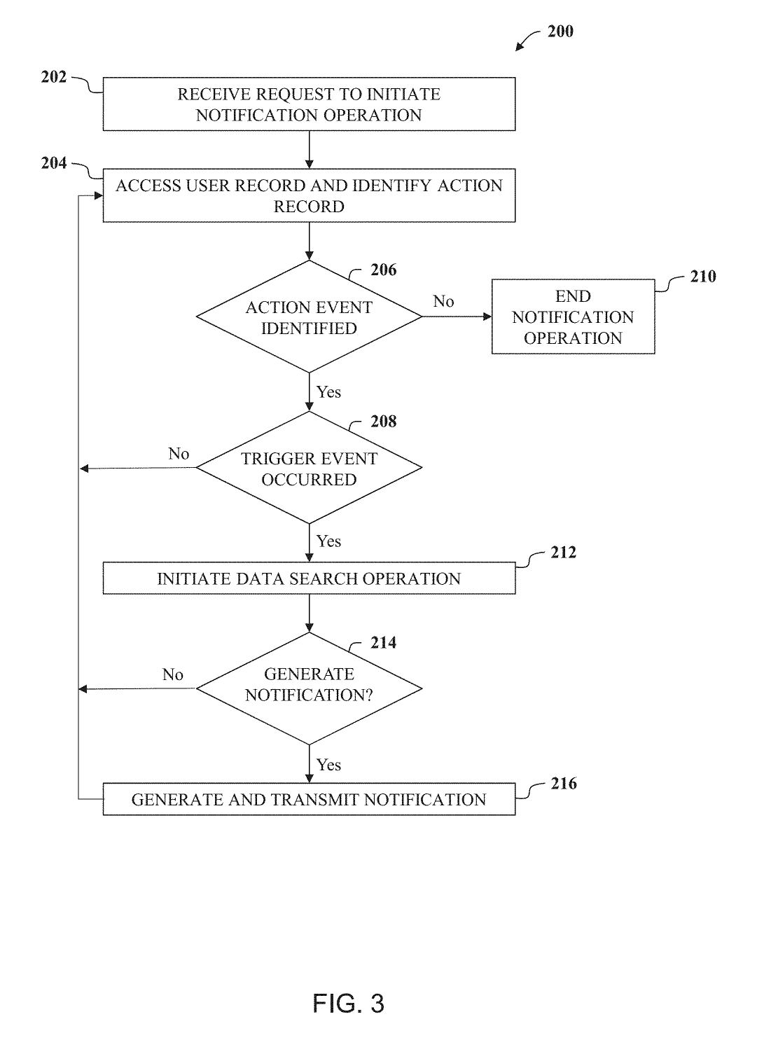

FIGS. 3-6 are flowcharts of methods 200, 300, 400, and 500 that may be used with the system 10 for monitoring activities of pharmacy customers and generating and displaying information to the pharmacy customers on a website via a mobile computing device. The methods include a plurality of steps. Each method step may be performed independently of, or in combination with, other method steps. Portions of the methods may be performed by any one of, or any combination of, the components of the system 10. FIGS. 12-20 are exemplary graphical displays that may be displayed by the system 10.

In the illustrated embodiment, in method step 202, the pharmacy account server 38 receives a request to initiate a notification operation to monitor an activity of a pharmacy customer. The request includes a corresponding user ID. In one embodiment, the request may be received from a mobile computing device 20 associated with a pharmacy customer. In another embodiment, the request may be initiated by the customer via the pharmacy website. In addition, the pharmacy account server 38 may be programmed to initiate a notification operation at a predefined period of time and/or upon receiving an indication of activities associated with a pharmacy customer.

In method step 204, the pharmacy account server 38 accesses the user pharmacy account list 46 being stored in the database 44 to determine a user pharmacy account records 48 associated with the received user ID. Upon determining the corresponding user pharmacy account 48 the pharmacy account server 38 identifies pharmaceutical drug data included in the corresponding user pharmacy account 48 to determine if the user pharmacy account record 48 includes action records 58 corresponding to the identified pharmaceutical drug data.

In method step 206, the pharmacy account server 38 determines if the identified user pharmacy account records 48 includes an action record 58 including instructions associated with operations to be performed by the system 10. If the identified user pharmacy account records 48 includes an action record 58, the pharmacy account server 38 initiates method step 208. If the pharmacy account server 38 determines that the identified user pharmacy account records 48 does not include an action record 58, the pharmacy account server 38 proceeds to method step 210 and terminates the notification operation.

In method step 208, upon identifying an action record 58 associated with a pharmaceutical drug included in the user pharmacy account record 48, the pharmacy account server 38 accesses the action record 58 to determine the action event data indicating a data search operation and the triggering event data indicating a corresponding triggering event associated with the corresponding pharmaceutical drug. Upon determining the corresponding triggering event, the pharmacy account server 38 determines whether the identified triggering event has occurred. For example, in one embodiment, the triggering event may include a purchase being made by the consumer. The pharmacy account server 38 then determines that the triggering event has occurred upon detecting a purchase being made by the consumer. In addition, the triggering event may include a calendar event. The pharmacy account server 38 determines that the triggering event has occurred upon detecting the occurrence of the calendar event such as, for example, the occurrence of a predefined time of day and/or a user selected calendar day. If the pharmacy account server 38 detects the occurrence of the triggering event, the pharmacy account server 38 initiates method step 212 to initiate the action event. If the pharmacy account server 38 does not detect the occurrence of the triggering event, the pharmacy account server 38 returns to step 204 and determines if any additional action records 58 are included in the identified user pharmacy account record 48.

In method step 212, the pharmacy account server 38 initiates a data search operation associated with the corresponding action event data upon detecting the occurrence of the triggering event and determines an outcome of the data search operation. For example, in one embodiment, the data search operation may include generating a search query including search terms associated with the corresponding pharmaceutical drug and transmitting the search query to the search engine server 40 with a request to review e-receipt data associated with recent consumer purchases. For example, in one embodiment, the pharmacy account server 38 may generate search terms including foods that may interact with the corresponding pharmaceutical drug and request the search engine server 40 to review e-receipt data to identify foods included in recent customer purchases that may interact with the corresponding pharmaceutical drug.

In method step 214, the pharmacy account server 38 determines the outcome of the data search operation and determines whether to generate a pharmacy notification message based on the determined outcome. For example, in one embodiment, the data search operation may include a search of e-receipt data using search terms indicating foods and/or drugs that may interact with the corresponding pharmaceutical drug. The pharmacy account server 38 may determine to generate the notification message upon determining that the e-receipt data includes products that match the search terms. In one embodiment, the data search operation may include accessing a 3^{rd} party computer server 16 to obtain environmental information. The pharmacy account server 38 may request location data from the mobile computing device 20 such as, for example, current GPS location data, and determine a current geographic location of the mobile computing device 20 based on the received location data. The pharmacy account server 38 may transmit a search query to the search engine server 40 including the mobile device location data and request the search engine server 40 to review the data received from the 3^{rd} party computer server 16 to identify environmental data matching the location of the mobile computing device 20. The pharmacy account server 38 may then determine an environmental condition of the location of the mobile computing device 20 and generate the notification message if the determined environmental condition is different from a predefined condition.

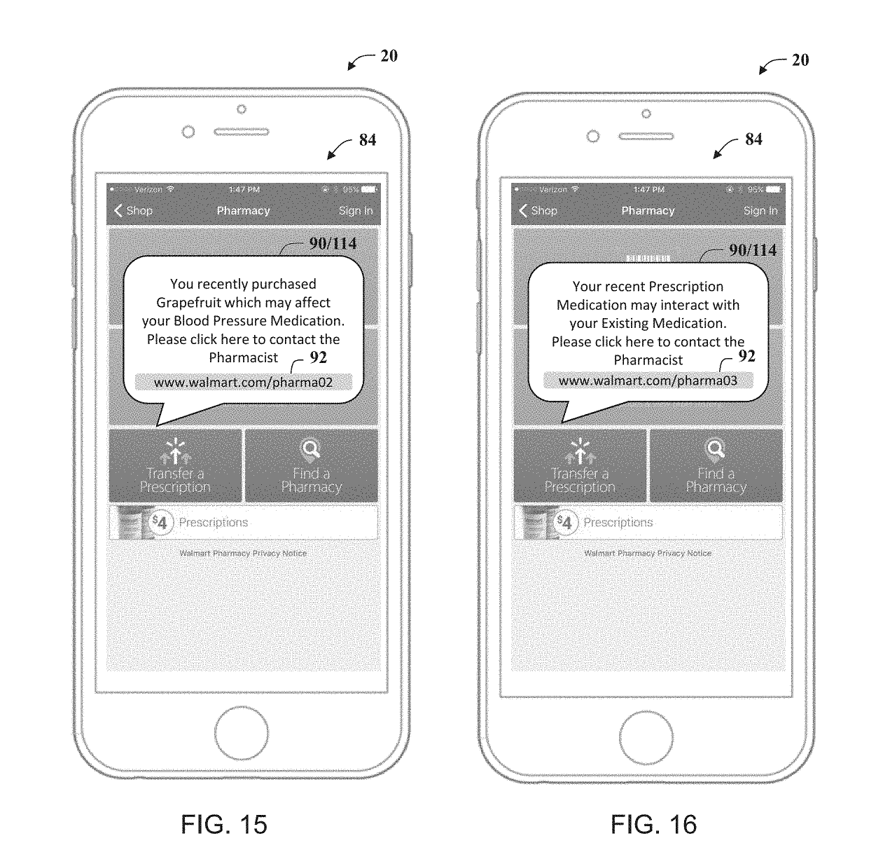

In method step 216, the pharmacy account server 38 generates and transmits a pharmacy notification message to the pharmacy customer. In the illustrated embodiment, the pharmacy account server 38 generates and transmits a signal including the notification message to the mobile computing device 20 to cause the mobile computing device 20 to display the notification message on the mobile computing device 20. For example, the pharmacy account server 38 may generate a drug interaction notification 114 (shown in FIGS. 15-16) upon detecting the purchase of a food and/or drug that may interact with the current pharmaceutical drug. In addition, the pharmacy account server 38 may generate a reminder notification 116 (shown in FIG. 14) upon determining an environmental condition associated with the mobile device is different than a predefined condition. In one embodiment, the pharmacy account server 38 may request the website hosting server 34 to generate the notification message including a hyperlink including a pharmaceutical drug ID to allow the pharmacy customer to receive additional information associated with the notification message. Upon displaying the notification message 90 to the mobile computing device 20, the user may access the hyperlink 92 to send instructions to the system 10 to request additional information. For example, the pharmacy account server 38 may receive a signal from the mobile computing device indicating that the user has accessed the hyperlink including the pharmaceutical drug ID, access the list of pharmaceutical drug records being stored in the database retrieve the pharmaceutical drug record corresponding to the received pharmaceutical drug ID, and generate and display a drug information webpage 94 on the mobile computing device including information included in the retrieved pharmaceutical drug record.

In one embodiment, the system 10 may access the corresponding user pharmacy account records 48 to determine a messaging API associated with an operating system of the mobile computing device 20 and generates the notification message as a function of the retrieved messaging API to enable the mobile computing device 20 to display the received message. In one embodiment, each user account record includes information associated with the mobile computing device 20 including a unique mobile ID and message API. In another embodiment, the user pharmacy account records 48 may include a message preferences, such as, for example, an email, text message, push messaging, automated phone call, and the like. The pharmacy account server 38 identifies the messaging preference associated with the user pharmacy account records 48 and generates the notification message based on the message preference. In addition, the pharmacy account server 38 may also access the messaging information 74 to identify contact information associated with additional users associated with the pharmacy customer and generate and transmit similar notifications including the information associated with the pharmacy customer to the additional users designated by the pharmacy customer and identified in the messaging information 74.

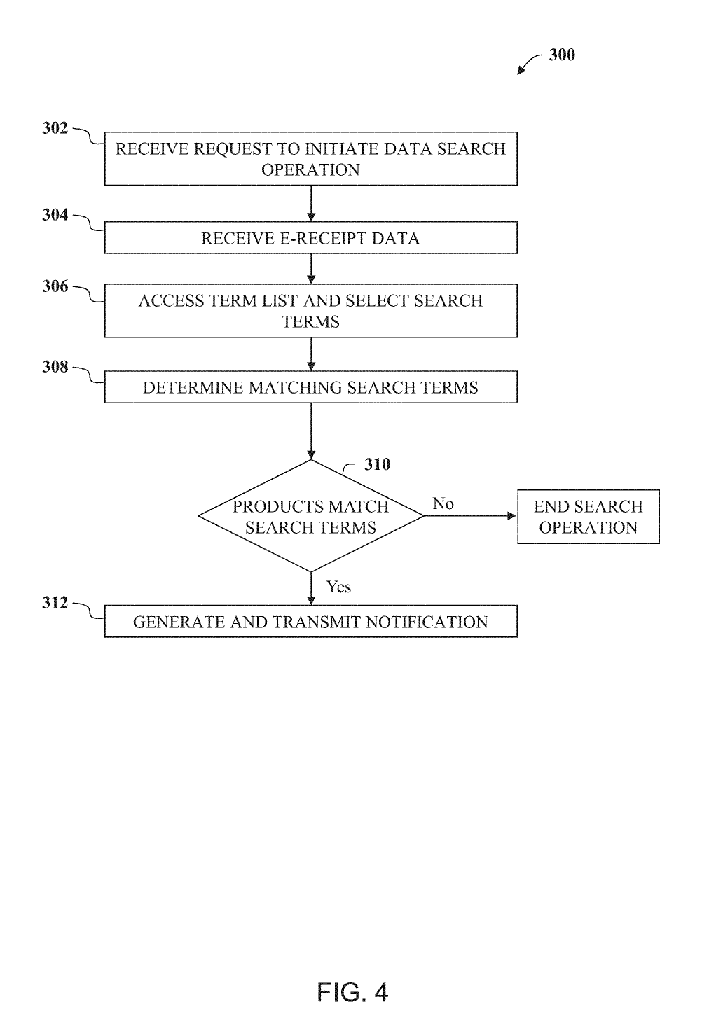

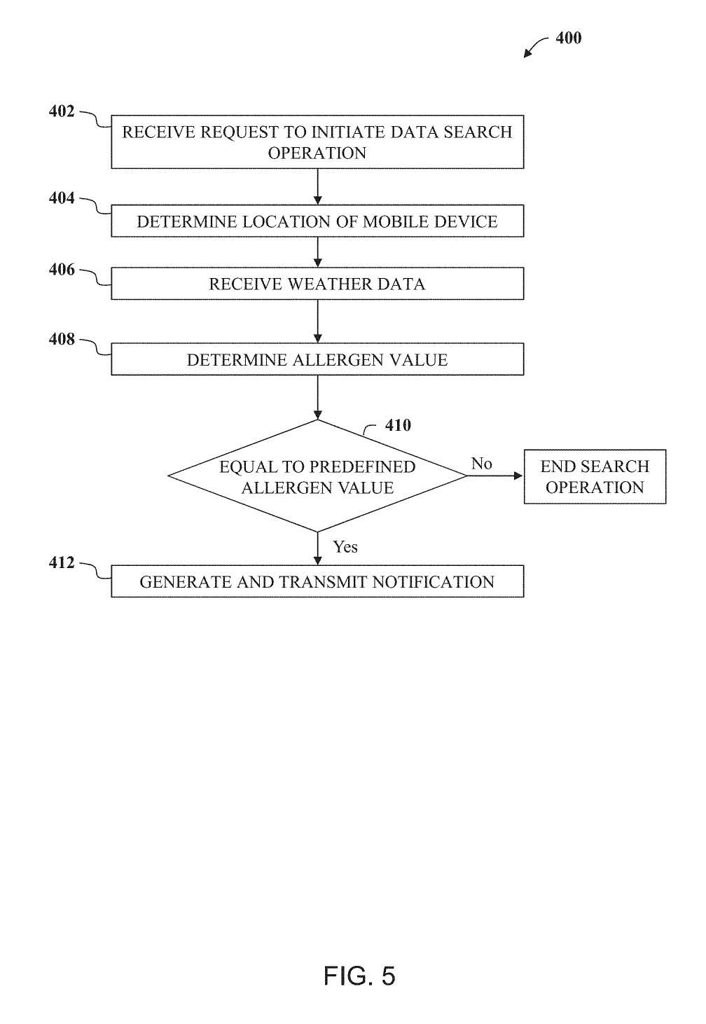

Referring to FIGS. 4-5, methods 300 and 400 may be initiated by the system 10 for use in conducting a data search operation. In the illustrated embodiment, in method step 302, the search engine server 40 receives a request from the pharmacy account server 38 to initiate a data search operation to determine a potential drug interaction with a pharmaceutical drug currently used by the pharmacy customer.

In method step 304, the search engine server 40 requests and receives e-receipt data from the e-receipts server 36.

In method step 306, the pharmacy account server 38 identifies the pharmaceutical drug associated with the action record 58 including a drug category, and accesses the drug interaction search term list 76 to identify search terms associated with the identified pharmaceutical drug and/or the action event data associated with the identified action record 58. The pharmacy account server transmits the search terms to the search engine server 40.

In method step 308, the search engine server 40 reviews the received e-receipt data to identify products being purchase by the pharmacy customer that are relevant to and/or matching the received search terms.

In method step 310, the search engine server 40 returns the search results to the pharmacy account server 38. In method step 312, the pharmacy account server 38 then generates and transmits the notification message upon identifying one or more purchased products matching the search terms.

In method step 402, the search engine server 40 receives a request from the pharmacy account server 38 to initiate a data search operation to determine an environmental condition of a geographic location associated with the pharmacy customer.

In method step 404, the pharmacy account server 38 requests location data from the mobile computing device 20 such as, for example, GPS location data, and determines a geographic location of the mobile computing device 20 based on the received location data.

In method step 406, the pharmacy account server 38 request and receives environmental data from the 3^{rd} party computer server 16 and transmits the environmental data and the location data to the search engine server 40. The search engine server 40 reviews the environmental data to determine environmental data matching the location data of the mobile computing device 20 transmits the matching environmental data to the pharmacy account server 38.

In method step 408, the pharmacy account server 38 generates allergen information based on the received environmental data and determines an allergen value associated with the location of the mobile computing device 20.

In method step 410, the pharmacy account server 38 determines if the determined allergen value of equal to a predefined allergen value. For example, the pharmacy account server 38 may access the user pharmacy account record to determine the predefine allergen count included in the action data associated with a pharmaceutical drug.

In method step 412, the pharmacy account server 38 generates and transmits a reminder message 114 including information associated with the local allergen information upon determining that the determined allergen information different than a predefined allergen value. For example, in one embodiment, the pharmacy customer may be currently using allergy medication. The pharmacy account server 38 may generate and display a reminder message notifying the customer that the local pollen count is above a predefined level and that the pharmacy customer may wish to take their allergy medication.

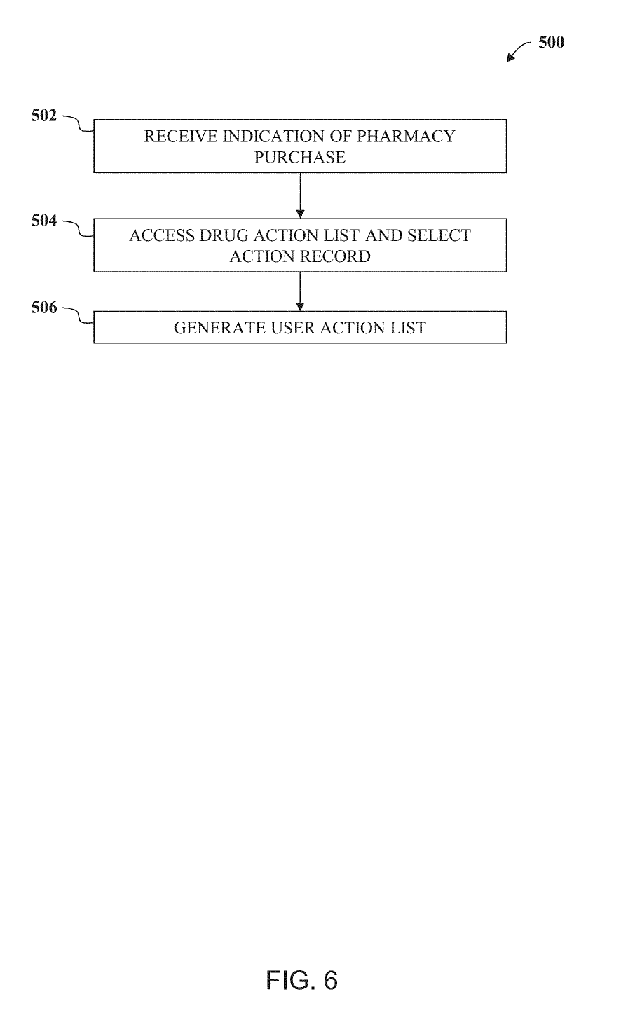

Referring to FIG. 6, method 500 may be initiated by the system 10 for use in generating a user pharmacy account record 48 that may be used to monitor activities of a pharmacy customer. In method step 502, the pharmacy account server 38 receives an indication of a pharmacy purchase being made by a pharmacy customer. The pharmacy purchase may include a request to file prescription medication received via the pharmacy webpage 86 and/or a signal indicating a pharmacy purchase received from the e-receipts server 36. The request includes a pharmaceutical drug ID and a user ID.

In method step 504, the pharmacy account server 38 accesses the drug action list 54 including pharmaceutical drug action records being stored in the database 44 and selects a pharmaceutical drug action record 56 as a function of the received pharmaceutical drug ID. The pharmacy account server 38 may also access the event action list 64 to retrieve the action event data associated with the identified action record 58.

In method step 506, the pharmacy account server 38 generates a user event action record 72 including the corresponding user ID and the action event data associated with the determined action record 58. The pharmacy account server 38 also modifies the user action event list 70 to include the generated user event action record 72. During a notification operation described in methods 300 and 400, the pharmacy account server 38 may access the user action event list 70 to determine action records associated with corresponding user IDs. In one embedment, the pharmacy account server 38 may identify a user pharmaceutical account associated with the User ID, and generate and/or modify the user pharmacy account record associated with the received user ID to include the determined action event data associated with the selected pharmaceutical drug action record.

In one embodiment, the system 10 may store the user action event list 70 in the mobile computing device database and a mobile application including programs to cause the mobile computing device 20 to perform some or all of the functions performed by the system server 100. For example, in one embodiment, the system server 100 may install a mobile application in the memory device of the mobile computing device 20 that is accessible by the user. When the user accesses the mobile application, the processor of the mobile computing device 20 may access the user action event list 70 being stored in the database an initiate one or more actions associated with user action event records 72 included in the user action event list 70.

In general, the system 10 is configured to generate pharmacy user account records that include action event data that enable the system to monitor activities of pharmacy customers. For example, the system 10 may monitor the activities of pharmacy customers for potential drug interactions and provide pharmacy notifications to customers when potential drug interactions with existing pharmaceutical medications currently used by the customer is detected. Moreover, the system 10 is configured to provide push notifications to the mobile devices associated with the pharmacy customers to provide information about potential drug interactions and allow the customers to interact with an operate the system 10. By generating user pharmacy account records that include action event records associated with customer activities including triggering events, the system 10 improves the speed and functionality of known computing systems by reducing the amount of computing time required to monitor customer activity, thus reducing the computing resources required to generate and display relevant pharmacy messages to pharmacy customers.

A controller, computing device, server or computer, such as described herein, includes at least one or more processors or processing units and a system memory (see above). The controller typically also includes at least some form of computer readable media. By way of example and not limitation, computer readable media may include computer storage media and communication media. Computer storage media may include volatile and nonvolatile, removable and non-removable media implemented in any method or technology that enables storage of information, such as computer readable instructions, data structures, program modules, or other data. Communication media typically embody computer readable instructions, data structures, program modules, or other data in a modulated data signal such as a carrier wave or other transport mechanism and include any information delivery media. Those skilled in the art should be familiar with the modulated data signal, which has one or more of its characteristics set or changed in such a manner as to encode information in the signal. Combinations of any of the above are also included within the scope of computer readable media.

The order of execution or performance of the operations in the embodiments of the invention illustrated and described herein is not essential, unless otherwise specified. That is, the operations described herein may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

In some embodiments, a processor, as described herein, includes any programmable system including systems and microcontrollers, reduced instruction set circuits (RISC), application specific integrated circuits (ASIC), programmable logic circuits (PLC), and any other circuit or processor capable of executing the functions described herein. The above examples are exemplary only, and thus are not intended to limit in any way the definition and/or meaning of the term processor.

In some embodiments, a database, as described herein, includes any collection of data including hierarchical databases, relational databases, flat file databases, object-relational databases, object oriented databases, and any other structured collection of records or data that is stored in a computer system. The above examples are exemplary only, and thus are not intended to limit in any way the definition and/or meaning of the term database. Examples of databases include, but are not limited to only including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention.

What is claimed is:

1. A system, comprising:
a database including a list of user pharmacy account records, each user pharmacy account record including a unique user ID associated with a user, pharmaceutical drug data indicating a corresponding pharmaceutical drug associated with the corresponding user, and an action record associated with the corresponding pharmaceutical drug, the action record including triggering event data indicating a triggering event and action event data indicating data search operations; and
a server computer including a processor coupled to a memory device, the processor programmed to:
receive a request to display a notification message to a user, the request including a corresponding user ID;
access the database and identify a user pharmacy account record associated with the received user ID;
determine a pharmaceutical drug included in the identified user pharmacy account record and determine an action record associated with the determined pharmaceutical drug including action event data;
initiate a data search operation associated with the corresponding action event data and determine an outcome of the data search operation;
generate a notification message as a function of the outcome of the data search operation; and
generate and transmit a signal including the notification message to the mobile computing device to cause the mobile computing device to display the notification message on the mobile computing device.

2. A system in accordance with claim 1, wherein the server computer is programmed to:
determine triggering event data associated with the determined pharmaceutical drug; and
detect an occurrence of a triggering event as a function of the triggering event data;
initiate the data search operation associated with the corresponding action event data upon detecting the occurrence of the triggering event.

3. A system in accordance with claim 1, wherein the server computer is programmed to:
receive electronic receipt data including product information associated with consumer products purchased by the user;
initiate the data search operation including:
accessing a drug integration search term list being stored in the database to determine search terms associated with the determined pharmaceutical drug; and
review the electronic receipt data to determine if at least one consumer product included in the electronic receipt data includes product information matching the determined search terms; and
transmit the notification message upon determining at least one consumer product includes product information matching one or more of the determined search terms associated with the determined pharmaceutical drug.

4. A system in accordance with claim 3, wherein the search terms are associated with at least one of other pharmaceutical drugs and food products.

5. A system in accordance with claim 2, wherein the triggering event includes a purchase of consumer products by the user, the server computer is programmed to receive the electronic receipt data associated with the corresponding purchase of consumer products.

6. A system in accordance with claim 1, wherein the server computer is programmed to:
receive weather data including location data and associated allergen data;
initiate the data search operation including:
determining a current location of the mobile computing device;
reviewing the received weather data to identify location data matching the current location of the mobile computing device;
determine an allergen count value as a function of the allergen data associated with the identified location data; and
transmit the notification message upon determining the determined allergen count value to be equal to a predefined allergen count value.

7. A system in accordance with claim 6, wherein the triggering condition includes an occurrence of a calendar event.

8. A system in accordance with claim 1, wherein the server system in programmed to:
receive a signal indicating a purchase of a pharmaceutical drug, the signal including a pharmaceutical drug ID and a user ID;
access a drug action list including pharmaceutical drug action records being stored in the database, each pharmaceutical drug record including a drug identifier and corresponding action records including associated triggering event data and associated action event data;
select a pharmaceutical drug action record as a function of the received pharmaceutical drug ID;
determine the action event data associated with the selected pharmaceutical drug action record; and
generate a user pharmacy account record associated with the received user ID including the determined action event data associated with the selected pharmaceutical drug action record.

9. A system in accordance with claim 1, wherein the server computer system is programmed to:
generate the notification message including a hyperlink including a pharmaceutical drug ID;
receive a signal from the mobile computing device indicating that the user has accessed the hyperlink;
access a list of pharmaceutical drug records being stored in the database, each pharmaceutical drug record associated with a pharmaceutical drug and including a corresponding pharmaceutical drug ID and corresponding pharmaceutical drug data information associated including information associated with the corresponding pharmaceutical drug;
retrieve the pharmaceutical drug record corresponding to the received pharmaceutical drug ID; and
generate and display a webpage on the mobile computing device including information included in the retrieved pharmaceutical drug record.

10. A method comprising:
receiving a request to display a notification message to a user, the request including a corresponding user ID;
accessing a database including a list of user pharmacy account records, each user pharmacy account record including a unique user ID associated with a user, pharmaceutical drug data indicating a corresponding pharmaceutical drug associated with the corresponding user, and an action record associated with the corresponding pharmaceutical drug, the action record including triggering event data indicating a triggering event and action event data indicating data search operations;
identifying a user pharmacy account record associated with the received user ID;
determining a pharmaceutical drug included in the identified user pharmacy account record and determining an action record associated with the determined pharmaceutical drug including action event data;
initiating a data search operation associated with the corresponding action event data and determine an outcome of the data search operation;
generating a notification message as a function of the outcome of the data search operation; and
generating and transmitting a signal including the notification message to the mobile computing device to cause the mobile computing device to display the notification message on the mobile computing device.

11. A method in accordance with claim 10, further comprising:
determine triggering event data associated with the determined pharmaceutical drug; and
detect an occurrence of a triggering event as a function of the triggering event data;
initiate the data search operation associated with the corresponding action event data upon detecting the occurrence of the triggering event.

12. A method in accordance with claim 10, further comprising:
receiving electronic receipt data including product information associated with consumer products purchased by the user;
initiating the data search operation including:
accessing a drug integration search term list being stored in the database to determine search terms associated with the determined pharmaceutical drug; and
reviewing the electronic receipt data to determine if at least one consumer product included in the electronic receipt data includes product information matching the determined search terms; and
transmitting the notification message upon determining at least one consumer product includes product information matching one or more of the determined search terms associated with the determined pharmaceutical drug.

13. A method in accordance with claim 12, wherein the search terms are associated with at least one of other pharmaceutical drugs and food products.

14. A method in accordance with claim 12, wherein the triggering event includes a purchase of consumer products by the user, the method further comprising receiving the electronic receipt data associated with the corresponding purchase of consumer products.

15. A method in accordance with claim 10, further comprising:
receiving weather data including location data and associated allergen data;
initiating the data search operation including:
determining a current location of the mobile computing device;
reviewing the received weather data to identify location data matching the current location of the mobile computing device;
determine an allergen count value as a function of the allergen data associated with the identified location data; and
transmitting the notification message upon determining the determined allergen count value to be equal to a predefined allergen count value.

16. A method in accordance with claim 15, wherein the triggering condition includes an occurrence of a calendar event.

17. A method in accordance with claim 10, further comprising:
receiving a signal indicating a purchase of a pharmaceutical drug, the signal including a pharmaceutical drug ID and a user ID;
accessing a drug action list including pharmaceutical drug action records being stored in the database, each pharmaceutical drug record including a drug identifier and corresponding action records including associated triggering event data and associated action event data;
selecting a pharmaceutical drug action record as a function of the received pharmaceutical drug ID;
determining the action event data associated with the selected pharmaceutical drug action record; and
generating a user pharmacy account record associated with the received user ID including the determined action event data associated with the selected pharmaceutical drug action record.

18. A method in accordance with claim 10, further comprising:
generating the notification message including a hyperlink including a pharmaceutical drug ID;
receiving a signal from the mobile computing device indicating that the user has accessed the hyperlink;
accessing a list of pharmaceutical drug records being stored in the database, each pharmaceutical drug record associated with a pharmaceutical drug and including a corresponding pharmaceutical drug ID and corresponding pharmaceutical drug data information associated including information associated with the corresponding pharmaceutical drug;
retrieving the pharmaceutical drug record corresponding to the received pharmaceutical drug ID; and
generating and display a webpage on the mobile computing device including information included in the retrieved pharmaceutical drug record.

19. One or more non-transitory computer-readable storage media, having computer-executable instructions embodied thereon, wherein when executed by at least one processor, the computer-executable instructions cause the processor to:
receive a request to display a notification message to a user, the request including a corresponding user ID;
access a database including a list of user pharmacy account records, each user pharmacy account record including a unique user ID associated with a user, pharmaceutical drug data indicating a corresponding pharmaceutical drug associated with the corresponding user, and an action record associated with the corresponding pharmaceutical drug, the action record including triggering event data indicating a triggering event and action event data indicating data search operations;
identify a user pharmacy account record associated with the received user ID;
determine a pharmaceutical drug included in the identified pharmaceutical account record and determine an action record associated with the determined pharmaceutical drug including a corresponding triggering event data and action event data;
detect an occurrence of a triggering event as a function of the triggering event data;
initiate a data search operation associated with the corresponding action event data upon detecting the occurrence of the triggering event and determine an outcome of the data search operation;
generate a notification message as a function of the outcome of the data search operation; and
generate and transmit a signal including the notification message to the mobile computing device to cause the mobile computing device to display the notification message on the mobile computing device.

20. One or more non-transitory computer-readable storage media in accordance with claim 19, wherein the computer-executable instructions cause the processor to:
receive a signal indicating a purchase of a pharmaceutical drug, the signal including a pharmaceutical drug ID and a user ID;
access a drug action list including pharmaceutical drug action records being stored in the database, each pharmaceutical drug record including a drug identifier and corresponding action records including associated triggering event data and associated action event data;
select a pharmaceutical drug action record as a function of the received pharmaceutical drug ID;
determine the action event data associated with the selected pharmaceutical drug action record; and
generate a user pharmacy account record associated with the received user ID including the determined action event data associated with the selected pharmaceutical drug action record.
